(19) United States
(12) Patent Application Publication
(10) Pub. No.: US 2026/0320699 A1
(43) Pub. Date: Oct. 15, 2026

(54) PRODUCT INFORMATION DISPLAY METHOD AND ELECTRONIC DEVICE

(71) Applicant: Hangzhou Alibaba International Internet Industry Co., Ltd., Hangzhou City (CN)

(72) Inventors: Qiuming SONG, ShenZhen (CN); Quanrui MOU, ShenZhen (CN); Yu CHEN, ShenZhen (CN); Shanglin ZHOU, ShenZhen (CN); Shuai ZHU, ShenZhen (CN); Qinggang LI, ShenZhen (CN); Xin GUO, ShenZhen (CN); Fangzhou ZHAO, ShenZhen (CN); Danquan LI, ShenZhen (CN); Hongbo LI, ShenZhen (CN); Xiang LIU, ShenZhen (CN)

(21) Appl. No.: 19/711,928

(22) Filed: Jun. 17, 2026

Related U.S. Application Data
(63) Continuation of application No. PCT/CN2024/129494, filed on Nov. 1, 2024.

(30) Foreign Application Priority Data
Dec. 18, 2023 (CN) 202311741889.4

(51) Int. Cl. G06Q 40/10; G06F 16/28

(52) U.S. Cl. CPC G06Q 40/10; G06F 16/285

(57) ABSTRACT

The embodiments of the present disclosure disclose a product information display method, which includes: determining a target product to be displayed on a target page; requesting a customs classification and tax calculation service to obtain an estimated tax information result corresponding to the target product; the customs classification and tax calculation service is configured to classify the target product according to the product classification system of the customs system, and to estimate, based on the classification result and the customs tax rule information of the destination country/region applicable to the source country/region, the tax information involved in the process of exporting the target product from the source country/region to the destination country/region; and generating, based on the estimated tax information result, corresponding tax prompt information for the target product, so as to display the tax prompt information on the target page.

This application is a Continuation Application of International Patent Application No. PCT/CN2024/129494, filed on Nov. 1, 2024, which is based on and claims priority to and benefits of Chinese patent application filed with the China National Intellectual Property Administration on Dec. 18, 2023, with application number 202311741889.4, and entitled “Product Information Display Method and Electronic Device,” the entire contents of which are incorporated herein by reference.

### TECHNICAL FIELD

The present disclosure relates to the field of information processing technology, and more particularly to a product information display method and electronic device.

### BACKGROUND

In product information service systems such as cross-border e-commerce platforms, buyers and sellers may come from different countries. After a transaction is completed, cross-border transportation of goods is involved, and the costs incurred in this process may include not only the price of the goods themselves and shipping fees, but also customs duties, which may need to be borne by the buyer. With respect to the specific customs duty rates and tax amounts, these are typically determined when the goods clear customs, where the customs system of the destination country/region determines the customs classification code of the goods and calculates the tax rate and tax amount according to the corresponding tax rules, after which the buyer makes payment. In this process, since cross-border shipping cycles may be relatively long, a considerable amount of time elapses from the initial completion of the transaction to customs clearance and finally to receipt of the goods. At the time the transaction is completed, the buyer user may have already made payment, but additional costs may arise during the waiting period for receipt of goods. Consequently, for the buyer user, such additionally incurred costs may negatively affect the user experience. Furthermore, the existence of such uncertain information may also affect purchasing decisions. For some new users in particular, disputes with seller users may arise due to such additionally incurred costs, among other issues.

### SUMMARY

The present disclosure provides a product information display method and an electronic device, which are capable of displaying estimated information related to customs classification and tax calculation on a product information page, thereby facilitating improved user experience and improving metrics such as click-through rate and conversion rate of products.

The present disclosure provides the following solutions:

According to some embodiments, the present disclosure provides a product information display method, comprising:
maintaining, by a customs classification and tax calculation service platform, a tax rule database storing customs tax rule information for a plurality of destination countries/regions with respect to a plurality of source countries/regions, the tax rule database being periodically updated to reflect changes in customs tax rules;
performing, by the customs classification and tax calculation service platform, offline pre-computation of tax views for a plurality of products, wherein for each respective product, the offline pre-computation comprises:
   mapping product description information of the respective product to a customs classification code under a product classification system of a customs system based on at least a product name and a product category;
   for each combination of a source country/region and at least one destination country/region associated with the respective product, querying the tax rule database to determine estimated tax types and corresponding tax rates involved in a process of exporting the respective product from the source country/region to the at least one destination country/region; and
   persisting the tax view comprising the customs classification code, the estimated tax types, and the corresponding tax rates to a database for subsequent retrieval;
receiving, by a front-end application module, a request to render a target page for a buyer user, the target page comprising at least one target product;
determining a destination country/region of the buyer user based on geographic information associated with the buyer user;
retrieving, from the database, the persisted tax view corresponding to the at least one target product for a combination of the source country/region of the at least one target product and the determined destination country/region;
comparing, for the at least one target product, a tax rate under a target tax type from the retrieved tax view against a preset threshold;
in response to determining that the tax rate is below the preset threshold, generating a prompt label data object having a low tax rate attribute under the target tax type for the at least one target product; and
rendering the target page with the prompt label displayed as a visual indicator associated with the at least one target product, the prompt label incorporating tax-related selling point information derived from the pre-computed tax views.

According to some other embodiments, the present disclosure provides a product information display method, the method being applied to a client facing a first user, the first user comprising a buyer user, the method comprising:
determining a target product to be displayed on a target page;
using product description information, source country/region, and destination country/region information of the target product as input parameters, requesting the customs classification and tax calculation service to obtain an estimated tax information result corresponding to the target product; the customs classification and tax calculation service being configured to classify the target product according to the product classification system of the customs system, and to estimate, based on the classification result and the customs tax rule information of the destination country/region with respect to the source country/region, the tax information involved in the process of exporting the target product from the source country/region to the destination country/region;
generating, based on the estimated tax information result, corresponding tax prompt information for the target product, so as to display the tax prompt information on the target page.

The target page comprises a product list/product information feed page aggregating multiple products, or a product details information page corresponding to a single product.

The estimated tax information result comprises tax types and tax rate information involved;
the generating, based on the estimated tax information result, corresponding tax prompt information for the target product, comprises:
determining whether the tax rate under the target tax type is below the preset threshold, and if so, generating a prompt label having a low tax rate attribute under the target tax type for the target product, so as to display the prompt label on the target page.

Here, if the target page is a product details information page, the tax prompt information further includes numerical information regarding the tax rate.

A method for providing product tax information, the method being applied to a client facing a second user, the second user comprising a seller user or a product publisher user, the method comprises:
receiving a request initiated by a second user to query tax information of a published product;
using the product description information, source country/region, and at least one destination country/region information of the published product as input parameters, requesting the customs classification and tax calculation service to obtain the estimated tax information result corresponding to the published product, where the customs classification and tax calculation service is configured to classify the published product according to the product classification system of the customs system, and based on the classification result and the customs tax rule information of at least one destination country/region with respect to the source country/region of the published product, estimate the tax information respectively involved in the process of exporting the published product from the source country/region to at least one destination country/region;
displaying the classification result and the estimated tax information result of the published product on a target page.

The estimated tax information result comprises tax types and tax rate information involved;
the method further comprises:
determining whether the tax rate of the published product under the target tax type in the destination country/region with respect to the source country/region is below the preset threshold, and if so, generating a prompt label having a low tax rate attribute under the target tax type in the destination country/region for the published product, so as to display the prompt label on the target page.

The method further comprises:
providing an operation option for filtering published products by the prompt label having a low tax rate attribute, so as to display published products having a prompt label with a low tax rate attribute.

The method further comprises:
providing an operation option for providing feedback on whether to approve the classification result and the estimated tax information result of the published product, so as to trigger modification of the estimated tax information result by modifying the classification result when the result is not approved.

A product publishing method, comprises:
during the process of publishing a new product, using the product description information, source country/region, and at least one destination country/region information of the new product as input parameters, requesting the customs classification and tax calculation service to obtain the estimated tax information result corresponding to the new product, so that the customs classification and tax calculation service classifies the new product according to the product classification system of the customs system, and based on the classification result and the customs tax rule information of the destination country/region with respect to the source country/region of the new product, estimates the tax information involved in the process of exporting the new product from the source country/region to the destination country/region;
displaying the classification result and the estimated tax information result, and providing an operation option for providing feedback on whether to approve the classification result and the estimated tax information result of the new product, so as to trigger modification of the estimated tax information result by modifying the classification result when the result is not approved.

A product information modification processing method, comprises:
during the process of modifying information of a published product, using the modified product description information, source country/region, and at least one destination country/region information as input parameters, requesting the customs classification and tax calculation service to determine whether the classification result or estimated tax information result of the product has changed, where the customs classification and tax calculation service is configured to classify the product according to the product classification system of the customs system and the modified product description information, and compare with the classification result corresponding to before the information modification; if a change has occurred, estimating the tax information respectively involved in the process of exporting the product from the source country/region to at least one destination country/region based on the new classification result and the customs tax rule information of the destination country/region with respect to the source country/region;
displaying the new classification result and the corresponding estimated tax information result.

A product information display apparatus, the apparatus being applied to a client facing a first user, the first user comprising a buyer user, comprises:
a target product determination unit, configured to determine a target product to be displayed on a target page;
a tax information acquisition unit, configured to use the product description information, source country/region, and destination country/region information of the target product as input parameters, and request the customs classification and tax calculation service to obtain the estimated tax information result corresponding to the target product; wherein the customs classification and tax calculation service is configured to classify the target product according to the product classification system of the customs system, and estimate the tax information involved in the process of exporting the target product from the source country/region to the destination country/region based on the classification result and the customs tax rule information of the destination country/region with respect to the source country/region;
a tax information display unit, configured to generate corresponding tax prompt information for the target product based on the estimated tax information result, so as to display the tax prompt information on the target page.

A device for providing product tax information, the device being applied to a client facing a second user, the second user comprising a seller user or a product publisher user, comprises:
a request receiving unit, configured to receive a request initiated by a second user to query tax information of a published product;
a tax information acquisition unit, configured to use the product description information, source country/region, and at least one destination country/region information of the published product as input parameters, and request the customs classification and tax calculation service to obtain the estimated tax information result corresponding to the published product, where the customs classification and tax calculation service is configured to classify the published product according to the product classification system of the customs system, and estimate the tax information respectively involved in the process of exporting the published product from the source country/region to at least one destination country/region based on the classification result and the customs tax rule information of the at least one destination country/region with respect to the source country/region of the published product;
a tax information display unit, configured to display the classification result and the estimated tax information result of the published product on a target page.

A product publishing apparatus, comprises:
a tax information acquisition unit, configured to, during the process of publishing a new product, use the product description information, source country/region, and at least one destination country/region information of the new product as input parameters, and request the customs classification and tax calculation service to obtain the estimated tax information result corresponding to the new product, so that the customs classification and tax calculation service classifies the new product according to the product classification system of the customs system, and estimates the tax information involved in the process of exporting the new product from the source country/region to the destination country/region based on the classification result and the customs tax rule information of the destination country/region with respect to the source country/region of the new product;
a tax information display unit, configured to display the classification result and the estimated tax information result, and provide an operation option for providing feedback on whether the classification result and the estimated tax information result of the new product are approved, so as to trigger modification of the estimated tax information result by modifying the classification result when not approved.

A product information modification processing apparatus, comprises:
a request unit, configured to, during the process of modifying information of a published product, use the modified product description information, source country/region, and at least one destination country/region information as input parameters, and request the customs classification and tax calculation service to determine whether the classification result or estimated tax information result of the product has changed, where the customs classification and tax calculation service is configured to classify the product according to the product classification system of the customs system and the modified product description information, and compare with the classification result corresponding to before the information modification; if a change has occurred, estimating the tax information respectively involved in the process of exporting the product from the source country/region to at least one destination country/region based on the new classification result and the customs tax rule information of the destination country/region with respect to the source country/region;
a display unit configured to display the new classification result and the corresponding estimated tax information result.

A computer-readable storage medium comprises a computer program stored thereon, the computer program, when executed by a processor, implementing the steps of any one of the foregoing methods.

An electronic device, comprises:
one or more processors; and
a memory associated with the one or more processors, the memory configured to store program instructions that, when read and executed by the one or more processors, implement the steps of any one of the foregoing methods.

A computer program that, when executed in a computer, causes the computer to perform the steps of any one of the foregoing methods.

According to the specific embodiments provided by the present disclosure, the present disclosure discloses the following technical effects:

Through an embodiment of the present disclosure, a customs classification and tax calculation service may be provided in a cross-border product information service system, the service being capable of classifying commodities according to the product classification system of the customs system, and estimating, based on the classification result and the customs tax rule information of the destination country/region applicable to the source country/region, the tax information involved in the process of exporting a product from the source country/region to the destination country/region. In this way, when displaying information about the target product on the target page, the customs classification and tax calculation service may be used to obtain an estimated tax information result regarding the process of exporting the target product from its source country/region to the destination country/region, and tax prompt information corresponding to the target product may then be generated based on the estimated result, so that the tax prompt information may be displayed on the target page. This enables the first user (buyer user, etc.) to obtain tax-related information for specific commodities through the target page provided by the cross-border product information service system, thereby assisting the first user in making purchasing decisions.

In an optional implementation, the tax rate corresponding to a specific product may also be compared with a threshold value. If the tax rate is relatively low, a prompt label expressing a low tax rate attribute may be generated for the specific product. In this way, the first user may obtain qualitatively expressed tax information, and for the product, the “low tax rate” is displayed to the user as a “selling point,” which is conducive to improving metrics such as the click-through rate and conversion rate of the product.

In other embodiments, estimated tax information results regarding published products may also be provided to a second user such as a seller user. Tax information estimation results may also be provided during the process of publishing new products or modifying product information. The second user may also provide feedback on whether to approve specific estimated results, so as to improve the accuracy of the estimated classification results and tax information.

Of course, implementation of any product of the present disclosure does not necessarily need to achieve all of the advantages described above simultaneously.

### BRIEF DESCRIPTION OF THE DRAWINGS

In order to more clearly illustrate the embodiments of the present disclosure or the technical solutions in the prior art, the drawings required for use in the embodiments will be briefly introduced below. It is apparent that the drawings described below are merely some embodiments of the present disclosure, and those of ordinary skill in the art may obtain other drawings based on these drawings without any creative effort.

FIG. 1 is a schematic diagram of a system architecture provided by an embodiment of the present disclosure;

FIG. 2 is a flowchart of a first method provided by an embodiment of the present disclosure;

FIG. 3 is a schematic diagram of a user interface provided by an embodiment of the present disclosure;

FIG. 4 is a flowchart of a second method provided by an embodiment of the present disclosure;

FIG. 5 is a flowchart of a third method provided by an embodiment of the present disclosure;

FIG. 6 is a flowchart of a fourth method provided by an embodiment of the present disclosure;

FIG. 7 is a schematic diagram of an electronic device provided by an embodiment of the present disclosure.

### DETAILED DESCRIPTION OF THE EMBODIMENTS

The technical solutions in the embodiments of the present disclosure will be described clearly and completely with reference to the drawings in the embodiments of the present disclosure. Obviously, the described embodiments are only some embodiments of the present disclosure, not all embodiments. Based on the embodiments in the present disclosure, all other embodiments obtained by a person of ordinary skill in the art fall within the scope of protection of the present disclosure.

First, it should be noted that, for the specific tax calculation situation in cross-border transaction scenarios, this is typically handled by customs systems and other customs-related systems. That is, when a specific product is transported from a source country/region to a destination country/region, the customs system of the destination country/region classifies the product according to the product classification system of the customs system (which is a globally universal, systematic, and multipurpose international trade product classification system, where each product category corresponds to its own HS code, i.e., the customs classification code). Subsequently, based on the classification result and the customs tax rule information of the specific destination country/region with respect to the source country/region, the corresponding tax rate is determined and the specific tax amount to be paid is calculated.

For the same destination country/region, the corresponding tax rules will differ for different source countries/regions. Moreover, even for the same source country/region, the specific tax types and tax rates applicable to different categories of products may also differ, and these tax rules may change frequently. For example, for the same category of electronic products, the applicable tax types and tax rates may differ when exported from country/region A to country/region B versus when exported from country/region C to country/region B. For instance, country/region B may exempt certain tax types for electronic products from country/region A, or apply a reduced tax policy, and so on. In such cases, for a buyer user in country/region B, importing electronic products from country/region A may result in savings on certain tax costs, and so on. Furthermore, for the same category of electronic products also exported from country/region A to country/region B, the tax types and tax rates that country/region B imposes on country/region A for that category of products may also differ across different time periods.

However, for buyer users, in addition to factors such as the price of the product itself, the tax calculation situation corresponding to the product may also affect their decision-making process. In the prior art, since tax-related information cannot be obtained before or during a transaction, such tax information constitutes an uncertain factor for buyer users. During the decision-making process, they may want to know the specific tax calculation situation of a particular product, whether there are products of the same type available with a lower tax rate, and so on. Additionally, for seller users, they are also unable to predict the tax calculation situation that will apply when their published products are exported to multiple different destination countries/regions, whether it will affect their product sales volume, whether they need to adjust their sales strategy, and so on.

In response to the above, in the embodiments of the present disclosure, a customs classification and tax calculation service platform may first be provided in the cross-border product information service system. Through this customs classification and tax calculation service platform, relevant information about the product classification system of the customs system (which is generally globally applicable) may be stored; tax calculation rules for multiple destination countries/regions with respect to multiple different source countries/regions may also be configured into the service platform; and specific tax calculation rules may be updated periodically or non-periodically. In addition, a corresponding technical framework may also be provided. For a specific product, through this technical framework, based on the product description information of the product in the current product information service system (including the product name, the category to which it belongs in the product information service system, etc.), the product may be mapped to a category in the product classification system of the customs system—for example, the corresponding HS code may be determined; subsequently, based on the HS code, source country/region, and destination country/region (which may be one or more) of the product, by querying the customs tax rule information of the specific destination country/region with respect to the source country/region, an estimation may be made of how the customs and other authorities of the destination country/region will levy taxes on the product during the process of exporting the product from the source country/region to the destination country/region-for example, which tax types are involved, the tax rate for each tax type, and so on. That is to say, the customs classification and tax calculation service provided in the embodiments of the present disclosure is a service of an estimative nature; the estimated tax information result provided thereby is for reference by users, and when a formal transaction occurs, the actual tax situation shall still be subject to the notification of the customs system of the specific destination country/region.

On the basis of the above-mentioned customs classification and tax calculation service platform providing the above-mentioned service capabilities, it is also possible, through certain approaches, to “externalize” the capabilities provided by this service, so that it can more effectively help buyer users make purchasing decisions, help seller users manage products, and help platform operator personnel perform product selection/curation for marketing campaigns.

In order to achieve the above objectives, the embodiments of the present disclosure further provide a variety of implementations for “externalizing” the aforementioned specific customs classification and tax calculation service capabilities. For example, in scenarios facing buyer users, when displaying a product list/product information feed page or a product details information page to buyer users, content related to tax information of the products may be provided on the page. For example, the tax types, tax rates, and other information estimated by the aforementioned service platform may be displayed directly on the page. Alternatively, in a specific implementation, in order to avoid users having no concept of the magnitude of the tax rate value, a tax rate threshold may be preset in advance. After estimating the possible tax rate value of a product, the tax rate may also be compared with this threshold; if it is below the threshold, a label such as “low tax rate” may also be added to the product. In this way, tax rate-related information can become a “selling point” for such products, allowing users to more intuitively perceive the advantages of the product in terms of tax rates, thereby helping to improve metrics such as the product's conversion rate.

In a scenario facing seller users, a “customs duty view” page and other pages may be provided for seller users, through which the tax information corresponding to multiple products already published by a specific seller user can be displayed, including which tax types are required to be levied when each product is exported to multiple different destination countries/regions, the corresponding tax rates for each, and so on. In addition, based on preset thresholds and the like, labels such as “low tax rate” may also be added for products whose specific tax rate is below the threshold and the corresponding destination countries/regions, and seller users may also use this as a condition to filter products, or may further aggregate statistics on the number of products bearing the “low tax rate” label. Seller users may manage specific products based on this information, for example, selecting some products bearing the “low tax rate” label to participate in a certain marketing campaign, or temporarily delisting products with relatively high tax rates, and so on. In addition, seller users may also confirm the tax information provided by the service platform based on their own experience, and if any inaccuracies are found, they may also make manual modifications, and so on.

In addition, when a merchant publishes a new product, the calculation of the tax information for the new product may also be triggered, and the relevant data may be persisted to the database so that tax information-related labels can be added when the new product is displayed. When a merchant modifies the information of a published product, the product information on which the customs classification depends may be modified, which may cause the classification result of the product to change and, correspondingly, the tax information may also change. Therefore, during the product modification process, a process of determining whether the tax information of the product has changed may also be triggered. This determination process may still be implemented by the aforementioned customs classification and tax calculation service platform, and so on.

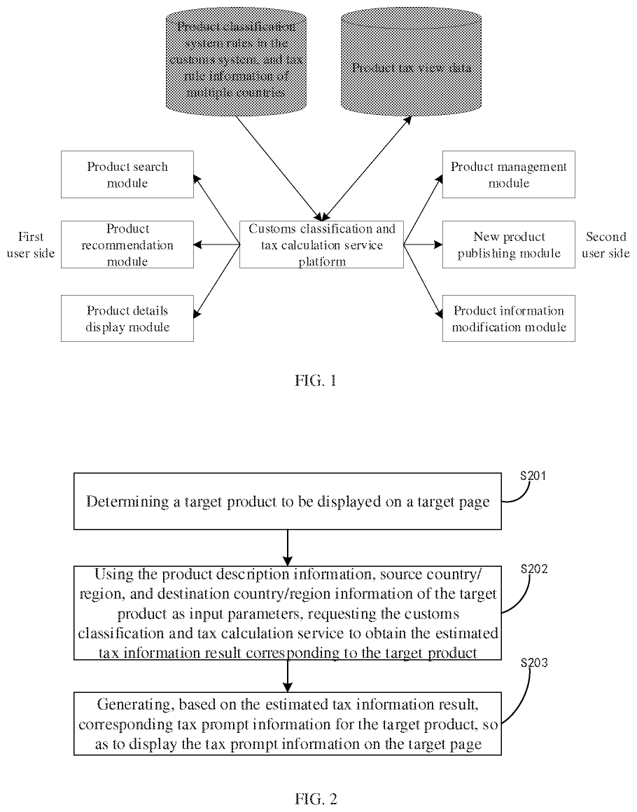

From a system architecture perspective, referring to FIG. 1, embodiments of the present disclosure may provide a customs classification and tax calculation service platform, which may provide basic capabilities for customs classification and tax calculation. These capabilities are “externalized” through multiple front-end application scenarios so as to provide buyer or seller users with information related to tax calculation. For example, the service platform may interface with application modules such as product search, product recommendation, and product detail display. After determining the list of products to be displayed, the product search or product recommendation module may obtain estimated tax information results for specific products from the service platform, including specific tax types, tax rates, whether the products meet the “low tax rate” conditions, and so on. Based on this information, information label tags may be generated for specific products for display on specific front-end pages, thereby enabling buyer users to access tax information for specific products on specific pages to assist in their purchasing decisions. Alternatively, the service platform may also interface with application modules oriented toward sellers, such as product management, new product publishing, and product information modification, to display estimated tax information results corresponding to multiple products published by users, generate corresponding estimated tax information results for newly published products, and save them to a specific database, and so on.

The following provides a detailed introduction to the specific implementation solutions provided by the embodiments of the present disclosure.

### Embodiment 1

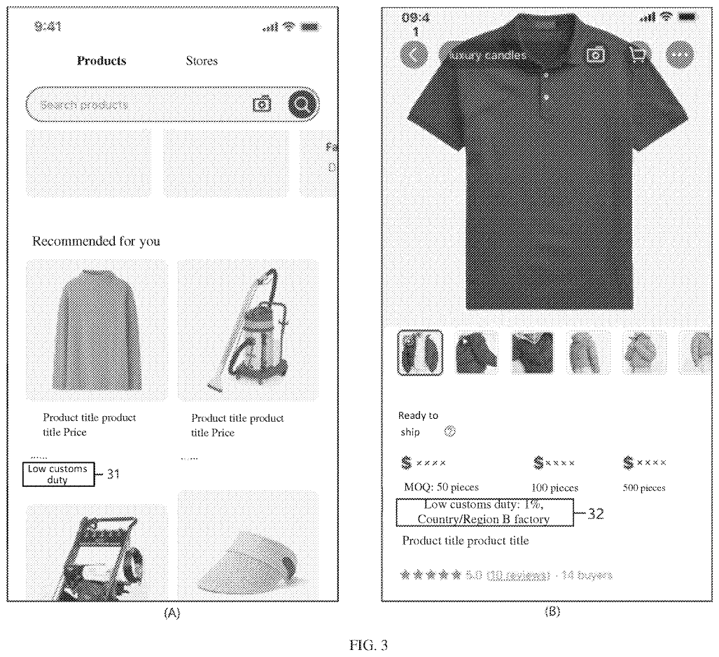

First, Embodiment 1 provides a product information display method from the perspective of a client facing buyer users (referred to as “first users” in the embodiments of the present disclosure). Referring to FIG. 2, the method includes:
S201: determining a target product to be displayed on a target page.

In this context, the target page may include a product list/product information feed page that aggregates multiple products (e.g., a product search results page, a recommended product information feed page, and the like), or a product details information page corresponding to a single product. The target product to be displayed on the target page may be determined specifically according to the particular application scenario; for example, in a product search scenario, the target product may be a matching product determined based on search criteria entered by the user; in a product recommendation scenario, the target product may be a personalized recommended product determined based on the user's historical behavior data and the like; in a product details scenario, whichever product's details information the user needs to access, the specific product details page is associated with that product, and so on.
S202: using the product description information, source country/region, and destination country/region information of the target product as input parameters, requesting the customs classification and tax calculation service to obtain the estimated tax information result corresponding to the target product; the customs classification and tax calculation service is used to classify the target product according to the product classification system of the customs system, and to estimate, based on the classification result and the customs tax rule information of the destination country/region with respect to the source country/region, the tax information involved in the process of exporting the target product from the source country/region to the destination country/region.

After determining the products to be displayed on the specific page, the products may be displayed on the page; however, before the actual display, it is also possible to determine whether specific products have certain “selling point” information, and then generate prompt labels based on such information, so that when displaying the products, such “selling point” information can be presented to users in the form of adding prompt labels to specific products. Under normal circumstances, such prompt labels may include information such as a specific product participating in a promotional activity (e.g., “spend 200 get 30 off, cross-store eligible,” etc.), “same style at lower price,” “XX person has paid,” and the like. In the embodiments of the present disclosure, such prompt labels may also be used to provide information about the tax aspects of a product.

In order to be able to provide the above-mentioned information labels related to tax information, the customs classification and tax calculation service may first be requested to obtain the tax information corresponding to the target product. When initiating the specific request, the product description information, source country/region, destination country/region information, and the like of the target product may be carried along, so that the customs classification and tax calculation service can return the tax information for the specific target product accordingly.

Here, regarding the product description information, it may specifically be identification information such as the product ID, or may further include the product name, category (the product category determined according to the product classification system of the product information service system), and the like, and such information may be obtained by querying the product information database. Regarding the source country/region information, it may specifically be configured by the seller user (which may be referred to as the second user) when publishing the product, and the destination country/region may be determined based on the geographic information associated with the first user, for example, determined based on the commonly used shipping address associated with the first user, and so on. After these pieces of information are determined, a corresponding query request may be initiated to the customs classification and tax calculation service.

The customs classification and tax calculation service may provide real-time tax information calculation services, or, in another more preferred approach, the tax information of products may also be calculated in an offline manner and consolidated into a relevant database, so that when it is specifically needed to display the tax information of a product, it may be obtained by querying the database, thereby improving response efficiency and avoiding display delays on the front-end page.

In the specific case of offline computation, the customs classification and tax calculation service may generate a respective “tax view” for each of multiple products in the system, and may store these views in a database or the like. Specifically, for the same product, based on the product description information of the product (including the name, category information in the product information service system, etc.), the product may be mapped to the product classification system of the customs system, completing the classification of the product under the product classification system of the customs system and determining the corresponding HS code and so on; subsequently, the corresponding tax calculation information, including tax types, tax rates, etc., may also be determined based on the source country/region and destination country/region of the product. The source country/region and destination country/region may both be determined by the seller when publishing the product. For the same product, the source country/region is generally fixed, while the destination country/region may be multiple; for example, when creating or publishing a product, the seller user may select the intended destination countries/regions, and the customs classification and tax calculation service may then estimate the respective tax calculation information for each of these destination countries/regions separately. That is, in the tax view of each product, it is possible to reflect which tax types are respectively involved for each destination country/region when exporting the product from its source country/region to multiple destination countries/regions, as well as the corresponding tax rates, and so on.

Of course, as mentioned above, even for products with the same HS code exported from the same source country/region to the same destination country/region, the tax rules may not be fixed and may vary during different periods. Therefore, in practical applications, certain measures may also be employed to track such rule changes and update them to the customs classification and tax calculation service platform in the embodiments of the present disclosure; correspondingly, the “tax view” corresponding to the products may also be updated, and so on.

In the case where the “tax views” of multiple products have been generated through offline computation, when the customs classification and tax calculation service platform receives a request to obtain tax information for a specific product, source country/region, and destination country/region, it may obtain the corresponding estimated tax information result by querying the “tax view” of that product and return it to the front-end application module (including the aforementioned product search, product recommendation, product details display, and the like). For example, assuming the source country/region of the current product is country A, the tax view may store the tax types involved and the corresponding tax rates when exporting the product from country A to multiple countries such as countries B, C, D, and so on. In this way, when displaying a target page (e.g., assuming it is a product recommendation page) to a specific first user, and the target page needs to display information about that product, the destination country/region where the first user is located (e.g., assuming it is country B) can be used to query the tax view for the tax types and corresponding tax rate information involved in exporting the product from country A to country B, which is then returned to the product recommendation application model, and so on.
S203: generating, based on the estimated tax information result, corresponding tax prompt information for the target product, so as to display the tax prompt information on the target page.

After the specific front-end application module receives the estimated tax information result returned by the customs classification and tax calculation service, it may generate corresponding tax prompt information for the target product. In this way, when displaying information about the target product on the target page, the tax prompt information may also be displayed, thereby enabling the user to view information about the tax aspects of the specific product from the page.

Here, since the specifically estimated tax information may include the involved tax types and tax rate information, when generating the above-mentioned tax prompt information, the estimated tax types and tax rate values may be directly used as the tax prompt information. Of course, although this approach can provide specific numerical values to users in a more direct manner, enabling users to obtain relatively more definitive information regarding tax aspects, considering that such directly displayed numerical values and other information may be relatively abstract, some less experienced first users may be more concerned about qualitative information such as whether the tax rate of the current product is high or low.

To this end, in a preferred implementation, after obtaining the estimated tax information result corresponding to the current product, it may further be determined whether the tax rate under the target tax type is below the preset threshold; if so, a prompt label having a low tax rate attribute under the target tax type may be generated for the target product, so that the prompt label is displayed on the target page. The specific threshold value may be set based on empirical values or the like; for example, the threshold may be determined by taking the average value, or the mode, or the like, of the distribution of tax rates applied by the same destination country/region to different source countries/regions. For example, the specific threshold value may be 5%, or another numerical value. After obtaining the estimated tax information result for a specific product, a comparison may be made with the tax rate threshold; if the tax rate is below the threshold, it indicates that the tax rate of the product is relatively low, and accordingly, a “low tax rate” label may be added to the corresponding product.

For example, suppose a certain destination country/region imposes a customs duty of 5% or higher on products of a certain category from most source countries/regions; the threshold may then be set to 5%. In this case, if the destination country/region only imposes a customs duty of 1% on a particular country/region B, then if the source country/region of a product in that category is B, a “low tax rate” label may be added to it. In this way, for users, seeing a specific product bearing a “low tax rate” label can alleviate their concerns or doubts about incurring high taxes when purchasing the product, which is conducive to helping them make purchasing decisions. Therefore, for products, this “low tax rate” label may serve as a kind of “selling point” (i.e., benefit point) information for the product, which is conducive to improving indicators such as the click-through rate or conversion rate of the product.

For example, as shown in FIG. 3(A), which illustrates the display of a product recommendation information feed page in a specific implementation, for products that meet the “low tax rate” condition, corresponding prompt labels may be added. For example, as shown at position 31 in FIG. 3(A), labels such as “low customs duty” may be displayed. In this way, while browsing the page, users can directly obtain the “selling point” information regarding “low customs duty” for specific products, which is beneficial for improving the click-through rate or conversion rate of the products.

In addition, if the specific target page is a product details information page, for products that meet the low tax rate condition, the tax prompt information may also provide numerical information about the tax rate, and may further include source country/region information, and so on. For example, as shown in FIG. 3(B), which illustrates the details information page of a certain product in a specific implementation, as shown at position 32 in FIG. 3(B), below the product's price, minimum order quantity, and other information, “low customs duty: 1%, Country/Region B factory” may be displayed, and so on. That is to say, not only can it be indicated that the customs duty of the product is relatively low, but the estimated customs duty tax rate of approximately 1% can also be directly provided, along with the information that the product originates from a factory in Country/Region B, and so on. In this way, users can obtain more detailed information regarding customs duty, and so on.

In summary, through Embodiment 1 of the present disclosure, a customs classification and tax calculation service can be provided in a cross-border product information service system. The service can classify products according to the product classification system of the customs system, and estimate, based on the classification result and the customs tax rule information of the destination country/region with respect to the source country/region, the tax information involved in the process of exporting the products from the source country/region to the destination country/region. In this way, when displaying information about the target product through a target page, the customs classification and tax calculation service can be used to obtain the estimated tax information result related to the process of exporting the target product from its source country/region to the destination country/region, and based on the estimated result, corresponding tax prompt information can be generated for the target product, so as to display the tax prompt information on the target page. This enables first users (buyer users and the like) to obtain tax-related information about specific products through the target page provided by the cross-border product information service system, thereby serving the purpose of helping first users make purchasing decisions and the like.

In an optional implementation, the tax rate corresponding to a specific product may also be compared with a threshold value. If the tax rate is relatively low, a prompt label expressing a low tax rate attribute may be generated for the specific product. In this way, the first user may obtain qualitatively expressed tax information, and for the product, the “low tax rate” is displayed to the user as a “selling point,” which is conducive to improving metrics such as the click-through rate and conversion rate of the product.

### Embodiment 2

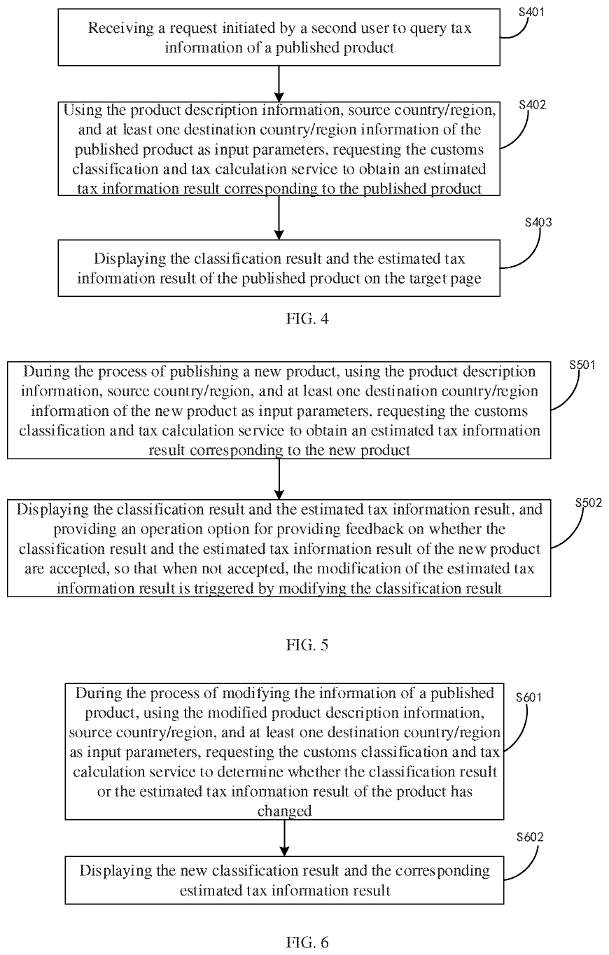

This Embodiment 2 provides, from the perspective of a client facing a second user, a method for providing product tax information, in which the second user includes a seller user or a product publisher user. Specifically, referring to FIG. 4, the method may include:
S401: receiving a request initiated by a second user to query tax information of a published product.

Specifically, access entries for the second user to query product tax information may be provided through various pages in a client facing the second user, for example, including a product management page, pages or resource slots related to product competitiveness queries, and so on. The second user may initiate a request to query tax information of a published product through the above access entries.
S402: using the product description information, source country/region, and at least one destination country/region information of the published product as input parameters, requesting the customs classification and tax calculation service to obtain an estimated tax information result corresponding to the published product, where the customs classification and tax calculation service is configured to classify the published product according to the product classification system of the customs system, and to estimate the tax information respectively involved in the process of exporting the published product from the source country/region to at least one destination country/region, based on the classification result and customs tax rule information of at least one destination country/region with respect to the source country/region of the published product.

After initiating a specific request, a list of published products associated with the current second user may be determined, and then the product description information, source country/region, and at least one destination country/region information of the published product may be used as input parameters to request the customs classification and tax calculation service to obtain an estimated tax information result corresponding to the published product. The manner in which the specific customs classification and tax calculation service generates the estimated tax information result may be referred to the description in Embodiment 1, and will not be repeated here.
S403: displaying the classification result and the estimated tax information result of the published product on the target page.

After obtaining the classification result and the estimated tax information result of the specific published product, the results may be displayed on the target page. The specifically displayed page may be referred to as the “tax view” page of each published product associated with the second user, which may include information such as the tax types and tax rates involved when each published product is exported to multiple destination countries/regions.

In addition, when displaying the above tax view page to the second user, it may also be determined whether the tax rate of the published product under the target tax type in the destination country/region with respect to the source country/region is below a preset threshold; if so, a prompt label having a low tax rate attribute under the target tax type in the destination country/region is generated for the published product, so as to display the prompt label on the target page.

Furthermore, an operation option for filtering published products by the low tax rate attribute prompt label may also be provided, so as to display published products bearing the prompt label with a low tax rate attribute. In this way, the second user can filter and view products having a low tax rate label, and so on.

Moreover, since the specific customs classification and tax calculation service provides an estimation-based service, the estimated results it provides may be inaccurate, and such inaccuracy is usually caused by insufficient accuracy in classifying the products. In general, since a specific second user has a better understanding of the products they have published, if a product has an inaccurate classification, the second user is likely to be aware of it. Therefore, in actual applications, an operation option for providing feedback on whether the classification result and the estimated tax information result of the published product are accepted may also be provided on the aforementioned target page; if not accepted, the modification of the estimated tax information result may be triggered by modifying the classification result. That is, the second user may modify the classification result, after which the customs classification and tax calculation service may re-estimate and calculate the specific tax information based on the classification result modified by the user, and so on.

In this way, the second user can better understand the tax information of the products they have published. In addition, by having the second user determine whether to accept the specific classification result and estimated tax information result, the estimated results of the customs classification and tax calculation service can also be verified. After acceptance by the second user, the specific data is consolidated into the database, thereby improving the accuracy of the estimated tax information result displayed to the first user.

### Embodiment 3

In Embodiment 2 above, the customs classification and tax calculation service platform may perform offline estimated tax information computation for already-published existing listed products, and the second user may query the specific estimated results. In Embodiment 3, during the process of a second user publishing a new product, the customs classification and tax calculation service platform may also perform estimated tax information computation. If the second user does not accept the specific estimated results, modifications may also be made, and then data consolidation is performed. Specifically, Embodiment 3 provides a product publishing method; referring to FIG. 5, the method may include:
S501: during the process of publishing a new product, using the product description information, source country/region, and at least one destination country/region information of the new product as input parameters, requesting the customs classification and tax calculation service to obtain an estimated tax information result corresponding to the new product, so that the customs classification and tax calculation service classifies the new product according to the product classification system of the customs system, and estimates the tax information involved in the process of exporting the new product from the source country/region to the destination country/region, based on the classification result and the customs tax rule information of the destination country/region with respect to the source country/region of the new product.

During the process of publishing a new product, the second user may enter specific product description information, source country/region, at least one destination country/region information, and so on, and then the specific product publishing application module may request the customs classification and tax calculation service to obtain the estimated tax information result corresponding to the new product. The process by which the customs classification and tax calculation service specifically estimates tax information for the new product is similar to what has been described above and will not be elaborated here.
S502: displaying the classification result and the estimated tax information result, and providing an operation option for providing feedback on whether the classification result and the estimated tax information result of the new product are accepted, so that when not accepted, the modification of the estimated tax information result is triggered by modifying the classification result.

After obtaining the classification result and the estimated tax information result, the results may be displayed, and operation options may additionally be provided for giving feedback on whether the classification result and the estimated tax information result of the new product are accepted; when not accepted, a modification of the estimated tax information result may be triggered by modifying the classification result.

### Embodiment Four

In addition to triggering the estimation and calculation of tax information when publishing a new product, in actual applications, a second user may also modify the information of a published product during the process of managing products. If such modification involves information on which classification and estimated tax information depend, the corresponding classification result or estimated tax information result may change. Therefore, a determination process as to whether the classification result or tax information has changed may also be triggered within the product information modification process. Specifically, this fourth embodiment provides a product information modification processing method; referring to FIG. 6, the method may include:
S601: during the process of modifying the information of a published product, using the modified product description information, source country/region, and at least one destination country/region as input parameters, requesting the customs classification and tax calculation service to determine whether the classification result or the estimated tax information result of the product has changed, where the customs classification and tax calculation service is configured to classify the product according to the product classification system of the customs system and the modified product description information, and compare the classification result with the classification result corresponding to before the information modification; if a change has occurred, estimating the tax information respectively involved in the process of exporting the product from the source country/region to at least one destination country/region based on the new classification result and the customs tax rule information of the destination country/region with respect to the source country/region;

S602: displaying the new classification result and the corresponding estimated tax information result.

Regarding the parts not described in detail in Embodiments Two through Four above, reference may be made to Embodiment One and other parts of the present disclosure specification, and details are not repeated here.

It should be noted that the embodiments of the present disclosure may involve the use of user data. In actual applications, specific personal data of users may be used in the solutions described herein within the scope permitted by applicable laws and regulations, provided that the applicable laws and regulations of the country where the application is located are complied with (for example, the user has explicitly consented, the user has been effectively notified, etc.).

Corresponding to Embodiment One, the embodiments of the present disclosure further provide a product information display apparatus, where the apparatus is applied to a client facing a first user, the first user comprising a buyer user, and the apparatus comprises:
a target product determination unit, configured to determine a target product to be displayed on a target page;
a tax information acquisition unit, configured to use the product description information, source country/region, and destination country/region information of the target product as input parameters, and request the customs classification and tax calculation service to obtain the estimated tax information result corresponding to the target product; where the customs classification and tax calculation service is configured to classify the target product according to the product classification system of the customs system, and estimate the tax information involved in the process of exporting the target product from the source country/region to the destination country/region based on the classification result and the customs tax rule information of the destination country/region with respect to the source country/region;
a tax information display unit, configured to generate corresponding tax prompt information for the target product based on the estimated tax information result, so as to display the tax prompt information on the target page.

The target page comprises a product list/product information feed page aggregating multiple products, or a product details information page corresponding to a single product.

Specifically, the estimated tax information result comprises the tax types and tax rate information involved;

The tax information display unit may be specifically configured to: determining whether the tax rate under the target tax type is below the preset threshold, and if so, generating a prompt label having a low tax rate attribute under the target tax type for the target product, so as to display the prompt label on the target page.

Here, if the target page is a product details information page, the tax prompt information further includes numerical information regarding the tax rate.

Corresponding to Embodiment Two, the embodiments of the present disclosure further provide an apparatus for providing product tax information, where the apparatus is applied to a client facing a second user, the second user comprising a seller user or a product publisher user, and the apparatus comprises:
a request receiving unit, configured to receive a request initiated by a second user to query tax information of a published product;
a tax information acquisition unit, configured to use the product description information, source country/region, and at least one destination country/region information of the published product as input parameters, and request the customs classification and tax calculation service to obtain the estimated tax information result corresponding to the published product, where the customs classification and tax calculation service is configured to classify the published product according to the product classification system of the customs system, and estimate the tax information respectively involved in the process of exporting the published product from the source country/region to at least one destination country/region based on the classification result and the customs tax rule information of the at least one destination country/region with respect to the source country/region of the published product;
a tax information display unit, configured to display the classification result and the estimated tax information result of the published product on a target page.

The estimated tax information result comprises tax types and tax rate information involved;

At this point, the apparatus may further comprise:
a prompt label display unit, configured to determine whether the tax rate of the published product under the target tax type for the destination country/region with respect to the source country/region is below a preset threshold, and if so, generate a prompt label having a low tax rate attribute under the target tax type in the destination country/region for the published product, so as to display the prompt label on the target page.

In addition, the apparatus may further comprise:
a filtering unit, configured to provide an operation option for filtering published products according to the prompt label having a low tax rate attribute, so as to display published products having a prompt label with a low tax rate attribute;
a feedback unit configured to provide an operation option for providing feedback on whether to approve the classification result and the estimated tax information result of the published product, so that when the classification result is not approved, modification of the estimated tax information result is triggered by modifying the classification result.

Corresponding to Embodiment 3, the embodiments of the present disclosure further provide a product publishing apparatus, which may include:
a tax information acquisition unit, configured to, during the process of publishing a new product, use the product description information, source country/region, and at least one destination country/region information of the new product as input parameters, and request the customs classification and tax calculation service to obtain the estimated tax information result corresponding to the new product, so that the customs classification and tax calculation service classifies the new product according to the product classification system of the customs system, and estimates the tax information involved in the process of exporting the new product from the source country/region to the destination country/region based on the classification result and the customs tax rule information of the destination country/region with respect to the source country/region of the new product;
a tax information display unit, configured to display the classification result and the estimated tax information result, and provide an operation option for providing feedback on whether the classification result and the estimated tax information result of the new product are approved, so as to trigger modification of the estimated tax information result by modifying the classification result when not approved.

Corresponding to Embodiment 4, the embodiments of the present disclosure further provide a product information modification processing apparatus, which may include:
a request unit, configured to, during the process of modifying information of a published product, use the modified product description information, source country/region, and at least one destination country/region information as input parameters, and request the customs classification and tax calculation service to determine whether the classification result or estimated tax information result of the product has changed, where the customs classification and tax calculation service is configured to classify the product according to the product classification system of the customs system and the modified product description information, and compare with the classification result corresponding to before the information modification; if a change has occurred, estimating the tax information respectively involved in the process of exporting the product from the source country/region to at least one destination country/region based on the new classification result and the customs tax rule information of the destination country/region with respect to the source country/region;
a display unit configured to display the new classification result and the corresponding estimated tax information result.

In addition, the embodiments of the present disclosure further provide a computer-readable storage medium having a computer program stored thereon, which, when executed by a processor, implements the steps of the method described in any one of the foregoing method embodiments.

And an electronic device, comprising:
one or more processors; and
a memory associated with the one or more processors, the memory configured to store program instructions that, when read and executed by the one or more processors, implement the steps of the method described in any one of the foregoing method embodiments.

The embodiments of the present disclosure further provide a computer program that, when executed in a computer, causes the computer to perform the steps of the method described in any one of the foregoing method embodiments.

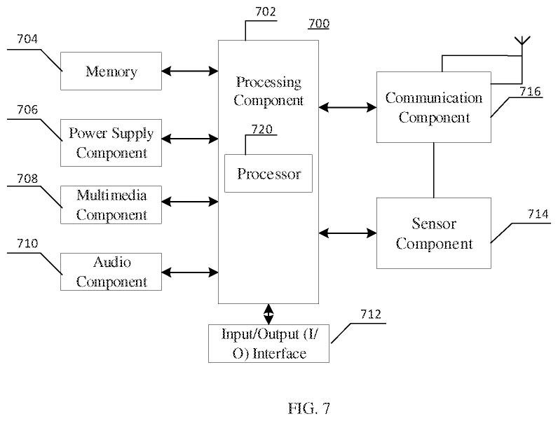

Among these, FIG. 7 exemplarily illustrates the architecture of an electronic device. For example, device 700 may be a mobile phone, a computer, a digital broadcasting terminal, a messaging device, a gaming console, a tablet device, a medical device, a fitness device, a personal digital assistant, an aircraft, or the like.

Referring to FIG. 7, device 700 may include one or more of the following components: processing component 702, memory 704, power supply component 706, multimedia component 708, audio component 710, input/output (I/O) interface 712, sensor component 714, and communication component 716.

Processing component 702 typically controls the overall operations of device 700, such as operations associated with display, phone calls, data communications, camera operations, and recording operations. Processing component 702 may include one or more processors 720 to execute instructions to complete all or part of the steps of the method provided by the technical solution of the present disclosure. Additionally, processing component 702 may include one or more modules to facilitate interaction between processing component 702 and other components. For example, processing component 702 may include a multimedia module to facilitate interaction between multimedia component 708 and processing component 702.

Memory 704 is configured to store various types of data to support operations at device 700. Examples of such data include instructions for any application or method operating on device 700, contact data, phone book data, messages, pictures, videos, and the like. Memory 704 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, a magnetic disk, or an optical disk.

Power supply component 706 provides power to the various components of device 700. Power supply component 706 may include a power management system, one or more power supplies, and other components associated with generating, managing, and distributing power for device 700.

The multimedia component 708 includes a screen that provides an output interface between the device 700 and a user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense the boundary of a touch or swipe action, but also detect the duration and pressure associated with the touch or swipe operation. In some embodiments, the multimedia component 708 includes a front-facing camera and/or a rear-facing camera. When the device 700 is in an operating mode, such as a shooting mode or a video mode, the front-facing camera and/or the rear-facing camera may receive external multimedia data. Each of the front-facing camera and the rear-facing camera may be a fixed optical lens system or one having focal length and optical zoom capability.

The audio component 710 is configured to output and/or input audio signals. For example, the audio component 710 includes a microphone (MIC) that, when the device 700 is in an operating mode such as a call mode, a recording mode, or a voice recognition mode, is configured to receive external audio signals. The received audio signals may be further stored in the memory 704 or transmitted via the communication component 716. In some embodiments, the audio component 710 further includes a speaker for outputting audio signals.

The I/O interface 712 provides an interface between the processing component 702 and peripheral interface modules, which may include a keyboard, a click wheel, buttons, and the like. These buttons may include, but are not limited to, a home button, a volume button, a start button, and a lock button.

The sensor component 714 includes one or more sensors for providing status assessments of various aspects of the device 700. For example, the sensor component 714 may detect the open/closed state of the device 700, the relative positioning of components, such as the display and the keypad of the device 700, and the sensor component 714 may also detect a change in position of the device 700 or a component of the device 700, the presence or absence of contact between a user and the device 700, the orientation or acceleration/deceleration of the device 700, and temperature changes of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an acceleration sensor, a gyroscope sensor, a magnetic sensor, a pressure sensor, or a temperature sensor.

The communication component 716 is configured to facilitate wired or wireless communication between the device 700 and other devices. The device 700 may access a wireless network based on a communication standard, such as WiFi, or a mobile communication network such as 2G, 3G, 4G/LTE, or 5G. In an exemplary embodiment, the communication component 716 receives a broadcast signal or broadcast-related information from an external broadcast management system via a broadcast channel. In an exemplary embodiment, the communication component 716 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an exemplary embodiment, the device 700 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components, for performing the methods described above.

In an exemplary embodiment, there is also provided a non-transitory computer-readable storage medium comprising instructions, such as the memory 704 comprising instructions, which are executable by the processor 720 of the device 700 to complete the method provided by the technical solution of the present disclosure. For example, the non-transitory computer-readable storage medium may be a ROM, a random access memory (RAM), a CD-ROM, a magnetic tape, a floppy disk, an optical data storage device, or the like.

From the description of the foregoing embodiments, those skilled in the art can clearly understand that the present disclosure may be implemented by means of software plus a necessary general-purpose hardware platform. Based on such understanding, the technical solution of the present disclosure, in essence or the part that contributes to the prior art, may be embodied in the form of a software product. The computer software product may be stored in a storage medium, such as a ROM/RAM, a magnetic disk, or an optical disc, and includes a number of instructions for causing a computer device (which may be a personal computer, a server, or a network device, etc.) to perform the methods described in the various embodiments or certain parts of the embodiments of the present disclosure.

Each of the embodiments in this specification is described in a progressive manner; the same or similar parts between the various embodiments may be referred to one another, and each embodiment focuses on the differences from the other embodiments. In particular, for a system or system embodiment, since it is substantially similar to the method embodiment, the description is relatively simple, and reference may be made to the relevant portions of the description of the method embodiment. The systems and system embodiments described above are merely illustrative, where the units described as separate components may or may not be physically separate, and the components displayed as units may or may not be physical units, i.e., they may be located in one place or distributed across multiple network units. Some or all of the modules may be selected according to actual needs to achieve the purpose of the solution of the present embodiment. Those of ordinary skill in the art can understand and implement the same without any creative effort.

The product information display method and electronic device provided by the present disclosure have been described in detail above. Specific examples have been used herein to illustrate the principles and implementations of the present disclosure. The descriptions of the above embodiments are only intended to help understand the method of the present disclosure and its core ideas. At the same time, for those of ordinary skill in the art, there will be changes in the specific implementations and scope of application based on the ideas of the present disclosure. In summary, the content of this specification should not be construed as limiting the present disclosure.

1. A product information display method, comprising:
maintaining, by a customs classification and tax calculation service platform, a tax rule database storing customs tax rule information for a plurality of destination countries/regions with respect to a plurality of source countries/regions, the tax rule database being periodically updated to reflect changes in customs tax rules;
performing, by the customs classification and tax calculation service platform, offline pre-computation of tax views for a plurality of products, wherein for each respective product, the offline pre-computation comprises:
mapping product description information of the respective product to a customs classification code under a product classification system of a customs system based on at least a product name and a product category;
for each combination of a source country/region and at least one destination country/region associated with the respective product, querying the tax rule database to determine estimated tax types and corresponding tax rates involved in a process of exporting the respective product from the source country/region to the at least one destination country/region; and
persisting the tax view comprising the customs classification code, the estimated tax types, and the corresponding tax rates to a database for subsequent retrieval;
receiving, by a front-end application module, a request to render a target page for a buyer user, the target page comprising at least one target product;
determining a destination country/region of the buyer user based on geographic information associated with the buyer user;
retrieving, from the database, the persisted tax view corresponding to the at least one target product for a combination of the source country/region of the at least one target product and the determined destination country/region;
comparing, for the at least one target product, a tax rate under a target tax type from the retrieved tax view against a preset threshold;
in response to determining that the tax rate is below the preset threshold, generating a prompt label data object having a low tax rate attribute under the target tax type for the at least one target product; and
rendering the target page with the prompt label displayed as a visual indicator associated with the at least one target product, the prompt label incorporating tax-related selling point information derived from the pre-computed tax views.

2. The method of claim 1, wherein determining the destination country/region of the buyer user comprises determining the destination country/region based on a commonly used shipping address associated with the buyer user.

3. The method of claim 1, wherein the customs classification code comprises a Harmonized System (HS) code determined under a globally universal product classification system of the customs system.

4. The method of claim 1, wherein the preset threshold is determined based on a distribution of tax rates applied by the destination country/region to different source countries/regions.

5. The method of claim 1, wherein the target page comprises a product list page, a product information feed page aggregating multiple products, or a product details information page corresponding to a single product.

6. The method of claim 1, wherein, when the target page is a product details information page, the method further comprises rendering numerical information regarding the tax rate and source country/region information in association with the prompt label on the target page.

7. The method of claim 1, further comprising:
detecting a change in customs tax rules in the tax rule database; and
in response to detecting the change, updating the persisted tax views corresponding to affected products to reflect the changed customs tax rules.

8. The method of claim 1, further comprising:
during a process of modifying product description information of a published product, determining whether the customs classification code of the published product has changed based on the modified product description information; and
in response to determining that the customs classification code has changed, re-computing the tax view for the published product based on a new customs classification code.

9. The method of claim 1, wherein the at least one destination country/region associated with the respective product comprises a plurality of destination countries/regions selected by a seller user when publishing the respective product, and wherein the offline pre-computation computes tax views for each of the plurality of destination countries/regions separately.

10. The method of claim 1, wherein retrieving the persisted tax view from the database is performed in response to a query from the front-end application module, thereby avoiding real-time computation and reducing display delays on the target page.

11. A non-transitory computer-readable storage medium configured with instructions executable by one or more processors to cause the one or more processors to perform the method of claim 1.

12. A product information display method, wherein the method is applied to a client facing a first user, the first user comprising a buyer user, the method comprising:
determining a target product to be displayed on a target page;
using product description information, source country/region, and destination country/region information of the target product as input parameters, requesting a customs classification and tax calculation service to obtain an estimated tax information result corresponding to the target product; the customs classification and tax calculation service being configured to classify the target product according to a product classification system of a customs system, and to estimate, based on a classification result and customs tax rule information of the destination country/region with respect to the source country/region, tax information involved in a process of exporting the target product from the source country/region to the destination country/region;
generating, based on the estimated tax information result, corresponding tax prompt information for the target product, so as to display the tax prompt information on the target page.

13. The method of claim 12, wherein
the target page comprises a product list/product information feed page aggregating multiple products, or a product details information page corresponding to a single product.

14. The method of claim 12, wherein
the estimated tax information result includes involved tax types and tax rate information;
the generating, based on the estimated tax information result, corresponding tax prompt information for the target product, comprises:
determining whether the tax rate under a target tax type is below a preset threshold, and if so, generating a prompt label having a low tax rate attribute under the target tax type for the target product, so as to display the prompt label on the target page.

15. The method of claim 14, wherein
if the target page is a product details information page, the tax prompt information further comprises numerical information regarding the tax rate.

16. A non-transitory computer-readable storage medium configured with instructions executable by one or more processors to cause the one or more processors to perform the method of claim 12.

17. A method for providing product tax information, wherein the method is applied to a client facing a second user, the second user comprising a seller user or a product publisher user, the method comprising:
receiving a request initiated by a second user to query tax information of a published product;
using product description information, source country/region, and at least one destination country/region information of the published product as input parameters, requesting a customs classification and tax calculation service to obtain an estimated tax information result corresponding to the published product, wherein the customs classification and tax calculation service is configured to classify the published product according to a product classification system of a customs system, and based on a classification result and customs tax rule information of the at least one destination country/region with respect to the source country/region of the published product, estimate tax information respectively involved in a process of exporting the published product from the source country/region to the at least one destination country/region;
displaying the classification result and the estimated tax information result of the published product on a target page.

18. The method of claim 17, wherein
the estimated tax information result includes involved tax types and tax rate information;
the method further comprises:
determining whether the tax rate of the published product under a target tax type in the destination country/region with respect to the source country/region is below a preset threshold, and if so, generating a prompt label having a low tax rate attribute under the target tax type in the destination country/region for the published product, so as to display the prompt label on the target page.

19. The method of claim 18, further comprising:
providing an operation option for filtering published products by the prompt label having a low tax rate attribute, so as to display published products having a prompt label with a low tax rate attribute.

20. The method of any one of claims 17, further comprising:
providing an operation option for providing feedback on whether to approve the classification result and the estimated tax information result of the published product, so as to trigger modification of the estimated tax information result by modifying the classification result when the result is not approved.
